(19) United States
(12) Patent Application Publication
(10) Pub. No.: US 2021/0078385 A1
(43) Pub. Date: Mar. 18, 2021

(54) Timed Auxiliary Automotive HVAC Apparatus

(71) Applicants: Yoir Bayer, Spring Valley, NY (US); Motty Bayer, Spring Valley, NY (US)

(72) Inventors: Yoir Bayer, Spring Valley, NY (US); Motty Bayer, Spring Valley, NY (US)

(21) Appl. No.: 16/572,859

(22) Filed: Sep. 17, 2019

(51) Int. Cl. B60H 1/00; B60H 1/22

(52) U.S. Cl. CPC B60H 1/00964; B60H 1/00507; B60H 1/2215; B60H 1/00428; B60H 1/0065

(57) ABSTRACT

A timed auxiliary automotive HVAC apparatus for quickly regulating vehicle temperature upon entry includes a control housing coupled within a dashboard of a vehicle. A plurality of controls is coupled to a faceplate of the control housing. A CPU is in operational communication with the plurality of controls. A blower fan is configured to be coupled within the dashboard and to be in operational communication with a battery of the vehicle and the CPU. A heating unit, a cooling unit, and a diverter solenoid are in operational communication with the blower fan and the CPU to heat or cool the vehicle through a discharge vent passing through a vent housing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to HVAC devices and more particularly pertains to a new HVAC device for quickly regulating vehicle temperature upon entry.

### (2) Description of Related Art Including Information Disclosed Under 37 CFR 1.97 and 1.98

The prior art relates to HVAC devices.

### BRIEF SUMMARY OF THE INVENTION

An embodiment of the disclosure meets the needs presented above by generally comprising a control housing having a housing body and a faceplate. The control housing is configured to be coupled within a dashboard of a vehicle. A plurality of controls is coupled to the faceplate of the control housing. A CPU is in operational communication with the plurality of controls. A blower fan is configured to be coupled within the dashboard and to be in operational communication with a battery of the vehicle and the CPU. A heating unit is in operational communication with the blower fan and the CPU. The heating unit is configured to be coupled within the dashboard. A cooling unit is in operational communication with the blower fan and the CPU. The cooling unit is configured to be coupled within the dashboard. A diverter solenoid is in operational communication with each of the heating unit and the cooling unit. The diverter solenoid is configured to be coupled within the dashboard. A vent housing is configured to be coupled to a dash underside of the dashboard and has a vent grille. A discharge vent is coupled to the vent housing and is in operational communication with the diverter solenoid. The discharge vent extends from the diverter solenoid to the vent grille.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front elevation view of a timed auxiliary automotive HVAC apparatus according to an embodiment of the disclosure.

FIG. 2 is a side elevation view of an embodiment of the disclosure.

FIG. 3 is an in-use view of an embodiment of the disclosure.

FIG. 4 is a block diagram of an embodiment of the disclosure.

### DETAILED DESCRIPTION OF THE INVENTION

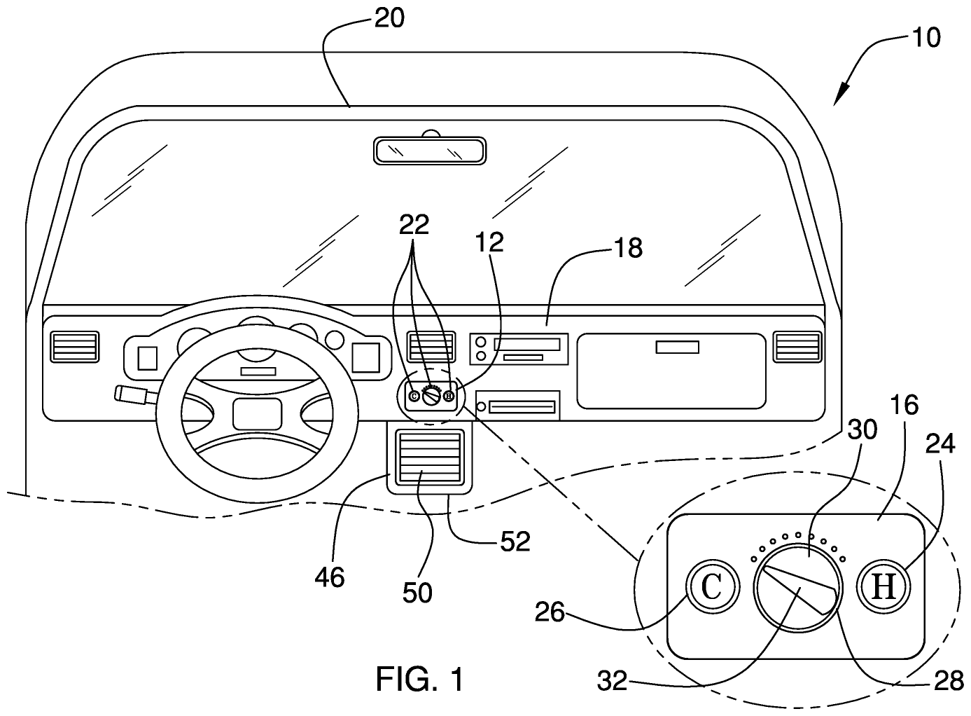

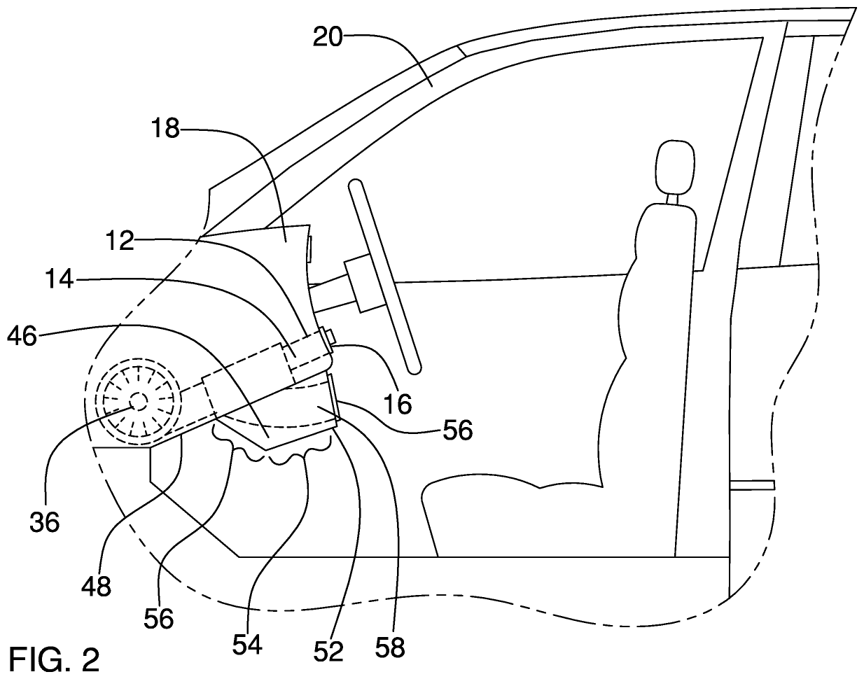

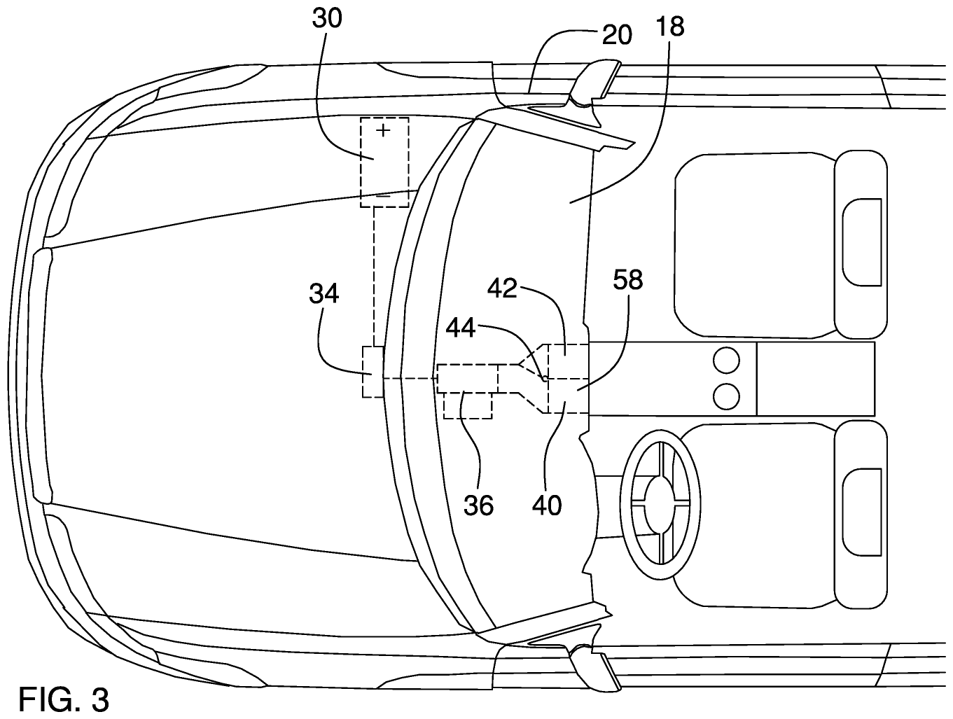

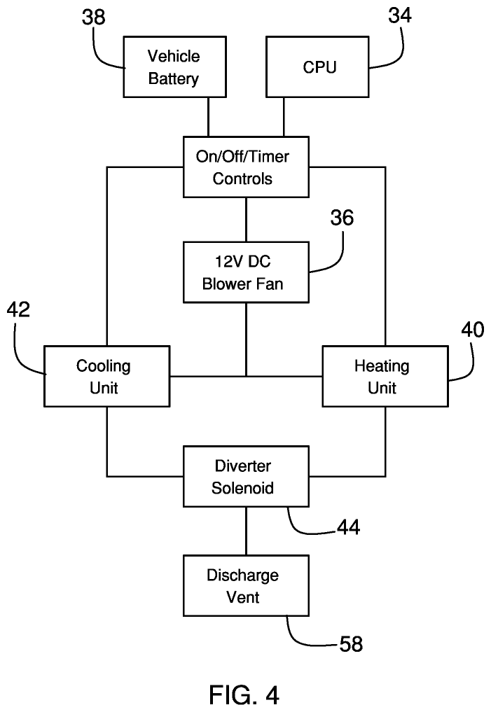

With reference now to the drawings, and in particular to FIGS. 1 through 4 thereof, a new HVAC device embodying the principles and concepts of an embodiment of the disclosure and generally designated by the reference numeral 10 will be described.

As best illustrated in FIGS. 1 through 4, the timed auxiliary automotive HVAC apparatus 10 generally comprises a control housing 12 having a housing body 14 and a faceplate 16. The control housing 12 is configured to be coupled within a dashboard 18 of a vehicle 20. A plurality of controls 22 is coupled to the faceplate 16 of the control housing and comprises a hot activator switch 24, a cold activator switch 26, and a timer 28. The hot activator switch 24 and the cold activator switch 26 may be circular buttons disposed on either side of the timer 28. The timer 28 has a circular dial body 30 and a tapered grip extension 32 to rotate the dial body 30 and to indicate the length of time the timer 28 is to be activated. A CPU 34 is in operational communication with the plurality of controls 22.

A blower fan 36 is configured to be coupled within the dashboard 18 and to be in operational communication with a battery 38 of the vehicle and the CPU 34. A heating unit 40 is in operational communication with the blower fan 36 and the CPU 34. The heating unit 40 is configured to be coupled within the dashboard 18. A cooling unit 42 is in operational communication with the blower fan 36 and the CPU 34. The cooling unit 42 is configured to be coupled within the dashboard 18 adjacent the heating unit 40. A diverter solenoid 44 is in operational communication with each of the heating unit 40 and the cooling unit 42 and is configured to be coupled within the dashboard 18. A vent housing 46 the is configured to be coupled to a dash underside 48 of the dashboard. The vent housing 46 has a vent grille 50 and the vent grille 50 may be louvered. A bottom side 52 of the vent housing may have a first portion 54 parallel to the dash underside 48 and a second portion 56 extending at an angle from the first portion 54 to the dash underside 48. A discharge vent 58 is coupled to the vent housing 46. The discharge vent 58 is in operational communication with the diverter solenoid 44 and extends to the vent grille 50.

In use, a user sets the timer 28 to the desired setting and presses either the hot activator switch 24 or the cold activator switch 26 to engage the heating unit 40 or the cooling unit 42, respectively. The diverter solenoid 44 moves to direct air from the blower fan 36 through the desired heating unit 40 or cooling unit 42 and out the discharge vent 58 for the preset amount of time to quickly create a comfortable climate within the vehicle 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A timed auxiliary automotive HVAC apparatus comprising:
a control housing, the control housing having a housing body and a faceplate, the control housing being configured to be coupled within a dashboard of a vehicle;
a plurality of controls coupled to the control housing, the plurality of controls being coupled to the faceplate;
a CPU, the CPU being in operational communication with the plurality of controls;
a blower fan, the blower fan being configured to be coupled within the dashboard and to be in operational communication with a battery of the vehicle and the CPU;
a heating unit, the heating unit being in operational communication with the blower fan and the CPU, the heating unit being configured to be coupled within the dashboard;
a cooling unit, the cooling unit being in operational communication with the blower fan and the CPU, the cooling unit being configured to be coupled within the dashboard;
a diverter solenoid, the diverter solenoid being in operational communication with each of the heating unit and the cooling unit, the diverter solenoid being configured to be coupled within the dashboard;
a vent housing, the vent housing being configured to be coupled to a dash underside of the dashboard, the vent housing having a vent grille; and
a discharge vent coupled to the vent housing, the discharge vent being in operational communication with the diverter solenoid and extending to the vent grille.

2. The timed auxiliary automotive HVAC apparatus of claim 1 further comprising the plurality of controls comprising a hot activator switch, a cold activator switch, and a timer.

3. The timed auxiliary automotive HVAC apparatus of claim 2 further comprising the hot activator switch and the cold activator switch being circular buttons.

4. The timed auxiliary automotive HVAC apparatus of claim 2 further comprising the timer having a circular dial body and a tapered grip extension, the tapered grip extension indicating the length of time the timer is to be activated.

5. The timed auxiliary automotive HVAC apparatus of claim 1 further comprising the vent grille being louvered.

6. The timed auxiliary automotive HVAC apparatus of claim 1 further comprising a bottom side of the vent housing having a first portion parallel to the dash underside and a second portion extending at an angle from the first portion to the dash underside.

7. A timed auxiliary automotive HVAC apparatus comprising:
a control housing, the control housing having a housing body and a faceplate, the control housing being configured to be coupled within a dashboard of a vehicle;
a plurality of controls coupled to the control housing, the plurality of controls being coupled to the faceplate, the plurality of controls comprising a hot activator switch, a cold activator switch, and a timer, the hot activator switch and the cold activator switch being circular buttons, the timer having a circular dial body and a tapered grip extension, the tapered grip extension indicating the length of time the timer is to be activated;
a CPU, the CPU being in operational communication with the plurality of controls;
a blower fan, the blower fan being configured to be coupled within the dashboard and to be in operational communication with a battery of the vehicle and the CPU;
a heating unit, the heating unit being in operational communication with the blower fan and the CPU, the heating unit being configured to be coupled within the dashboard;
a cooling unit, the cooling unit being in operational communication with the blower fan and the CPU, the cooling unit being configured to be coupled within the dashboard;
a diverter solenoid, the diverter solenoid being in operational communication with each of the heating unit and the cooling unit, the diverter solenoid being configured to be coupled within the dashboard;
a vent housing, the vent housing being configured to be coupled to a dash underside of the dashboard, the vent housing having a vent grille, the vent grille being louvered, a bottom side of the vent housing having a first portion parallel to the dash underside and a second portion extending at an angle from the first portion to the dash underside; and
a discharge vent coupled to the vent housing, the discharge vent being in operational communication with the diverter solenoid and extending to the vent grille.

8. A timed auxiliary automotive HVAC apparatus and vehicle combination comprising:
a vehicle, the vehicle having a dashboard;
a control housing, the control housing having a housing body and a faceplate, the control housing coupled within the dashboard of the vehicle;
a plurality of controls coupled to the control housing, the plurality of controls being coupled to the faceplate, the plurality of controls comprising a hot activator switch, a cold activator switch, and a timer, the hot activator switch and the cold activator switch being circular buttons, the timer having a circular dial body and a tapered grip extension, the tapered grip extension indicating the length of time the timer is to be activated;
a CPU, the CPU being in operational communication with the plurality of controls;
a blower fan, the blower fan being coupled within the dashboard and being in operational communication with a battery of the vehicle and the CPU;
a heating unit, the heating unit being in operational communication with the blower fan and the CPU, the heating unit being coupled within the dashboard;
a cooling unit, the cooling unit being in operational communication with the blower fan and the CPU, the cooling unit being coupled within the dashboard;
a diverter solenoid, the diverter solenoid being in operational communication with each of the heating unit and the cooling unit, the diverter solenoid being coupled within the dashboard;
a vent housing, the vent housing being coupled to a dash underside of the dashboard, the vent housing having a vent grille, the vent grille being louvered, a bottom side of the vent housing having a first portion parallel to the dash underside and a second portion extending at an angle from the first portion to the dash underside; and
a discharge vent coupled to the vent housing, the discharge vent being in operational communication with the diverter solenoid and extending to the vent grille.
